(19) United States
(12) Patent Application Publication
(10) Pub. No.: US 2016/0352751 A1
(43) Pub. Date: Dec. 1, 2016

(54) METHOD FOR CONTROLLING ACCESS TO A SERVICE

(71) Applicant: ORANGE, Paris (FR)

(72) Inventors: Micheline Perrufel, Pace (FR); Philippe Dussaume, Tremblay (FR); Olivier Bouchet, Rennes (FR)

(21) Appl. No.: 15/162,276

(22) Filed: May 23, 2016

(30) Foreign Application Priority Data
May 28, 2015 (FR) 1554828

(51) Int. Cl. H04L 29/06; H04L 29/08

(52) U.S. Cl. CPC H04L 63/102; H04L 67/10; H04L 67/16; H04L 63/123; H04L 63/0876

(57) ABSTRACT

The invention relates to a method for controlling the access to an on-line service, the access to the service being requested, via a communications network, by a terminal designed to receive data broadcast by a data transmission device using modulation of visible light producing a light beam, the method being characterized in that it comprises steps for generation of a token for accessing the service, for sending a command for broadcasting the token for accessing the service by the data transmission device using modulation of visible light, and when the terminal is in range of the light beam, for receiving, via the communications network, a request for accessing the service comprising a token for accessing the service originating from the terminal, for verifying the validity of the access token, and for access authorization when the token is valid. In a correlated manner, the invention relates to a method for accessing a service and devices, servers and terminals implementing these methods.

### TECHNICAL FIELD

The present invention relates to the field of telecommunications and, more particularly, to a method for authorizing access to a network from a public wireless access point.

### PRIOR ART

The widespread public availability of mobile terminals of the smartphone or tablet type is today driving establishments receiving the public to offer free Internet access to their guests. For example, it is common for a bar, a restaurant, a hotel or a boutique to offer Internet access to their clients via a wireless access point. These access points, commonly called “hotspots”, usually correspond to a Wi-Fi access point which may or may not be protected by a security key. When it is a secure connection, the users must input a security key on their terminal in order to access the service, such as for example a WEP (Wired Equivalent Privacy) key or WPA (Wi-Fi Protected Access) key. Since having to obtain then input this security key is often an impediment to the use of the service, hotspots are increasingly configured without a security key such that the clients can immediately benefit from the Internet access.

However, it is often the case that the Internet access is reserved only to clients of the establishment. For this purpose, the establishments may install a web portal through which the users are invited to identify themselves in order to access the Internet, by inputting a code for example. Such a code may be communicated to the client by means of a till receipt, for example, or verbally. In order to simplify the identification and automate the inputting of the code, the user is sometimes requested to scan a two-dimensional bar code.

Such systems are still awkward for the user as they require manipulations. Moreover, these systems cannot guarantee that only the clients of the establishment will be able to use the hotspot. Indeed, someone living nearby can easily obtain an access code allowing him to access the Internet through the hotspot if the range of the wireless access point allows it.

There accordingly exists a need for a technical solution enabling the access to a wireless network to be limited only to the users present in the establishment offering the service, without it being necessary to input a code.

### SUMMARY OF THE INVENTION

For this purpose, the invention relates to a method for controlling the access to an on-line service, the access to the service being requested, via a communications network, by a terminal designed to receive data broadcast by a data transmission device using modulation of visible light producing a light beam, the method being characterized in that it comprises the following steps implemented by a server:
Generation of a token for accessing the service,
Sending of a command for broadcasting the token for accessing the service by the data transmission device using modulation of visible light, and

When the terminal is in range of the light beam:
Reception, via the communications network, of a request for accessing the service comprising a token for accessing the service originating from the terminal,
Verification of the validity of the access token, and
Authorizing access when the token is valid.

An access token generated by a server is broadcast, upon a command from the server, by one or more transmission devices using modulation of visible light, such as for example LED bulbs conforming to the Li-Fi standard. The access token may for example be an http cookie, an access code or, alternatively, for example an encryption key. The token may be broadcast to several terminals or transmitted to a particular terminal. When a terminal is in range of such a transmission device, in other words when the light emitted by the device directly illuminates the terminal, the latter can receive the token by virtue of a suitable sensor. The terminal can then send a request for accessing the service including the token received. Upon reception of the request, the server checks the validity of the access token, by verifying for example that the token included in the request is actually a token that it has previously generated. In this way, only a terminal having been directly illuminated by a transmission device using modulation of visible light connected to the server can access the service. Thus, an establishment can authorize Internet access only to its clients without it being necessary for them to input any type of code. Furthermore, since the direct illumination area is limited and easily configurable, it is possible to precisely circumscribe the areas from which it is possible to access the service. This prevents individuals who are not clients from being able to take advantage of the Internet connection offered by situating themselves outside, but near to, an establishment offering such a service, as it is possible to do with the current Wi-Fi access points whose range often exceeds the boundaries of the establishment.

According to one particular embodiment, the method is such that it furthermore comprises a step for revoking the access token after the expiration of a validity period associated with the token.

The temporary validity of the token prevents a practice that would aim to store a token in memory in order to re-use it while the terminal is out of range of the light beam. For example, a date of generation or a maximum number of uses may be associated with the token. In this way, only the terminals continuously present in the light beam can access the service. This disposition prevents an individual from turning up in an establishment with the sole aim of obtaining a token allowing them to access the service at a later time from outside the establishment.

According to one particular embodiment, the method is such that the steps for generation of a token and for sending a broadcast command are periodically repeated.

Periodically generating and broadcasting a token allows the method to ensure that a terminal entering into the area of coverage will receive an access token without delay. For example, a server may generate and send out a token every 30 seconds in order for a user to only have to wait a few seconds before being able to access a service whose access is limited by the localization of the terminal.

According to one particular embodiment, the method is such that it comprises the following initial steps:
Reception, via the communications network, of an initial request for accessing the service originating from the terminal,
Obtaining identification data for the terminal,

The token being generated in association with the data for identification of the terminal and the step for verification of the validity of the token furthermore comprising a verification of the correspondence between the token generated and the data for identification of the terminal.

A first request for accessing the service is initially received. This request may be a conventional http request not comprising a token or else comprising an invalid or revoked token. Based on this request, the server obtains identification data for the terminal and generates a token in association with this data. For example, the server generates a token and stores in a table the data for identification of the terminal for which it has been generated. Upon a command from the server, the token generated is sent out by a data transmission device via visible light, in such a manner that the token can only be downloaded by a terminal localized in range of the illumination. When the token is downloaded by the terminal, the latter re-transmits the request for accessing the service adding the downloaded access token.

Upon receiving the request for accessing the service containing the token, the server checks its validity and verifies, in particular, the correspondence between the token generated and the identity of the terminal sending the request.

Such a disposition advantageously allows access to the service to be made secure by prohibiting token exchange between terminals because a token is generated for a particular terminal. Moreover, the terminal must necessarily be situated under a light beam when it generates a request in order to obtain the corresponding token. This also allows different access rights to be assigned according to the identity of the terminal.

In a correlated manner, the invention relates to a method for accessing a service on a terminal designed to receive data broadcast by a data transmission device using modulation of visible light producing a light beam, the method being characterized in that it comprises the following steps when the terminal is in range of the light beam:
Reception of a token for accessing the service via a communications interface designed to receive data transmitted by modulation of visible light,
Sending, via a communications network and for the attention of an access control server, of an access request comprising the access token received, and
Access to the service when the token is valid.

The terminal is equipped with an interface designed to receive data transmitted by a data transmission device using modulation of visible light. This may for example be a camera or a photosensitive sensor compatible with the Li-Fi standard. For example, the product Wysips® Connect marketed by the company Sunpartner Technologies allows any given screen to be transformed into a solar electricity producer and receiver of data via light. This interface allows the terminal to receive an authentication token broadcast by an LED illumination device for example and generated by a server following the reception of a request for accessing the service originating from the terminal. When it sends out a request for accessing the service, the terminal adds the token obtained to it so as to prove to the server that it really is localized within range of a light beam having broadcast the token. Thus, the method allows it, on the one hand, to be determined that the terminal wishing to gain access to a particular service really is localized at a location from which the access is authorized and, on the other hand, the inputting of an access code by the user to be avoided when he/she wishes to gain access to an on-line service from a hotspot.

According to another aspect, the invention relates to a device for controlling the access to an on-line service, the access to the service being requested by a terminal designed to receive data broadcast by a data transmission device using modulation of visible light producing a light beam, the device comprising:
A unit for generating an access token,
A communications interface designed to control the broadcast of the access token in the light beam generated by the data transmission device via modulation of visible light,
A communications interface designed to receive a request for accessing the service comprising an access token originating from the terminal,
A monitoring unit for verifying the validity of the access token, and
An authorization unit for authorizing the access to the service when the token is valid.

According to yet another aspect, the invention relates to a device for accessing a service comprising:
A communications unit designed to receive a token for accessing the service broadcast by a data transmission device using modulation of visible light producing a light beam,
A communications unit designed to send, via a communications network and for the attention of an access control server, an access request comprising the access token received, and
An access unit for accessing the service.

The invention also relates to a server comprising a device for controlling the access to a service.

The invention also relates to a terminal comprising a device for accessing a service such as described hereinabove.

The invention also relates to a computer program comprising the instructions for the execution of the access control method and/or the instructions for the execution of the access method, when the program is executed by a processor.

The invention also relates to an information medium readable by a processor on which a computer program is recorded comprising instructions for the execution of the steps of the access control method and/or the instructions for the execution of the access method. The information medium may be a non-transient information medium such as a hard disk, a flash memory, or an optical disk for example.

The various aforementioned embodiments or features may be added independently, or in combination with one another, to the steps of the access control method and/or to the steps of the access method.

The servers, terminals, devices, programs and information media offer at least advantages analogous to those endowed by the methods to which they relate.

### LIST OF THE FIGURES

Other features and advantages of the invention will become more clearly apparent upon reading the following description of one particular embodiment, presented simply by way of illustrative and non limiting example, and from the appended drawings, amongst which:

FIG. 1 illustrates, in a simplified manner, one architecture allowing the access control method and the access method according to one particular embodiment of the invention to be implemented,

FIG. 2 shows the main steps of the access control method according to one particular embodiment,

FIG. 3 illustrates the main steps of the access method according to one particular embodiment,

FIG. 4 is a timing diagram illustrating messages exchanged between various elements of an architecture suitable for implementing the invention according to one particular embodiment.

FIG. 5 shows schematically an access control device according to one particular embodiment, and

FIG. 6 shows a simplified view of an access device according to one particular embodiment.

### DETAILED DESCRIPTION

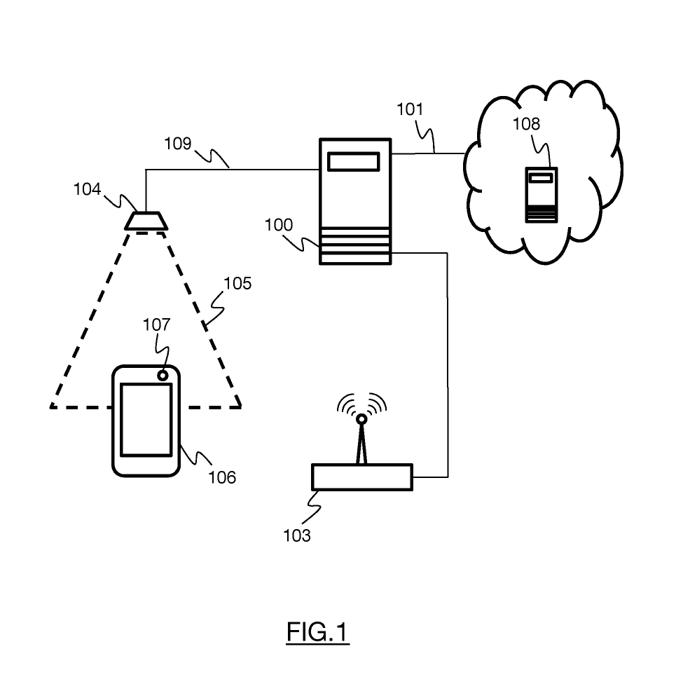

FIG. 1 illustrates an architecture suitable for implementing the invention according to one particular embodiment.

This architecture is installed for example in an establishment receiving the public, such as a restaurant, in order to offer Internet access free of charge to its clients.

The architecture comprises a server 100 disposing of an Internet access 101 and of a wireless access point 103, such as for example a Wi-Fi access point. The server 100 and the Wi-Fi access point 103 may also be combined within the same piece of equipment such as in a router modem or a domestic gateway. The server comprises a communications module designed to communicate with other equipment across a local network. The server may also comprise a communications module, such as for example an ADSL modem or optical fiber, suitable for establishing a communication with a server 108 across a communications network of the Internet type. The access point 103 is for example a Wi-Fi router of the ‘hotspot’ type configured in such a manner that the inputting of a security key, such as for example a WEP or WPA key, is not necessary for the terminals to be able to connect to it and to obtain an IP (Internet Protocol) address.

The architecture also comprises an illumination device 104 designed to transmit data by modulation of visible light, such as for example an LED bulb compatible with the Li-Fi standard. This bulb is connected to the server 100 using for example a technology of transmission by power-line communications (PLC), or by Wi-Fi, Bluetooth, Ethernet or any other type of connection. Thus, the server 100 can transmit data via the light rays 105 coming from the bulb 104.

FIG. 1 also shows a terminal 106 adapted for accessing a network via a Wi-Fi connection. When it connects to the network, the terminal obtains an IP address in a conventional manner and the address of a default gateway to which the data generated by the terminal will be sent. The default gateway is configured in such a manner that the server 100 can intercept the messages sent via the Wi-Fi interface of the terminal 106. The terminal 106 may be a smartphone, a tablet, a laptop computer, a games console, an on-line watch or any other device adapted for accessing the Internet. This terminal is equipped with a processor and with a memory designed to implement the access method according to the invention. The terminal 106 furthermore disposes of a sensor 107 designed to receive data transmitted via modulation of visible light, and in particular, for receiving and decoding the data transmitted by the illumination transmission device 104, such as for example an access token. The sensor 107 may or may not be integrated into the terminal 106. For example, the sensor may be a specialized photovoltaic cell or a camera integrated into the terminal, but it may also take the form of an external peripheral device such as a USB (Universal Serial Bus) peripheral connected to a laptop computer for example. It may also take the form of a screen having a photovoltaic capacitor. The sensor 107 may also be integrated into an accessory being worn, such as a wrist watch or a brooch, and transmit the data received in the light beam 105 to the terminal via a Bluetooth connection for example.

Thus, this architecture allows the terminal 106 to exchange data with the server 100 via a wireless connection and to receive data originating from this server by means of a light beam.

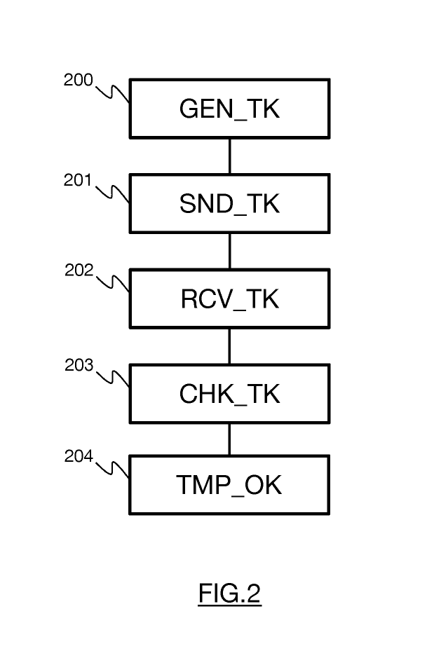

FIG. 2 illustrates the main steps of the access control method.

During a first step 200, the server generates a token for accessing a service. The token may correspond to conventional authentication data such as a user name/password pair, an http cookie, or again for example a security key. This authentication data may be constituted from data pre-configured in a database or a configuration file to which a hash function of the MD5 type is for example applied. According to one particular embodiment, the authentication data is a number or a series of arbitrary nature generated randomly and stored in a memory of the server. The token may be stored in a table of the server in association with the date and the time of the generation and/or an identifier of a terminal for which it has been generated. According to one particular embodiment, access rights to at least one service are associated with the access token. According to one particular embodiment, a new access token is generated periodically in order that a terminal is not able to store and to use a token at a later date while it is no longer in range of the light beam.

At the step 201, the server commands the broadcast of the token for accessing the service by at least one data transmission device using modulation of visible light. Such a device corresponds for example to an LED bulb adapted for modulating the light emitted at high frequency according to a particular data transmission protocol, such as for example a bulb compatible with the Li-Fi standard. Such a bulb generally comprises a network interface of the Wi-Fi, Bluetooth or CPL type allowing a unit of equipment to transmit data via the bulb. For example, the server 100 in FIG. 1 can communicate with the bulb 104 via the CPL network 109 and, in particular, send a data transfer command within the light beam 105 generated by the bulb 104. Thus, the server 100 commands the broadcast of the token for accessing the service by the data transmission device 104 using modulation of visible light. The access token thus transferred can be received by the terminal 106 by means of the photosensitive sensor 107 when it is in range of the light beam 105. According to one particular embodiment, the access token is broadcast periodically in order that a terminal can quickly receive a token when it comes into the range of a light beam such as the beam 105.

During the step 202, the server 100 receives a request for accessing the service sent by a terminal and comprising a token for accessing the service. This request is received via a network interface, such as for example a wireless network interface of the Wi-Fi type such as the access point 103. Thus, the server receives, for example during this step, an http request of the GET type sent by the terminal 106 for accessing a Web page. Aside from the conventional content of an http request, the request comprises authentication data generated from a token for accessing the service initially transmitted by means of the light beam at the step 201. For example, the authentication data may be constructed from a user name and a password or another secret data value included within the token to which the terminal applies a hash function, or else from the token itself.

The server checks the validity of the access token at the step 203 by verifying that the token present in the request received at the step 202 corresponds to a token generated at the step 200, by for example applying the hash function used by the terminal to the data transmitted within the token in order to verify the agreement of the result with the data sent by the terminal. According to one particular embodiment, the validity check also comprises a verification of the revocation status of the token and/or a verification that the time passed between the date of generation of the token and the date of the verification does not exceed a pre-determined period of time. For example, a token may be considered as invalid when the time period between its generation and the verification of its validity is longer than 5 minutes. When the validity period of the token has expired, the token can be revoked so that it can no longer be used.

When the token is valid, the server 100 authorizes the access to the service for the terminal having generated the request. For this purpose, the server removes the token from the request and transmits it to the destination network 108 via the Internet access 101.

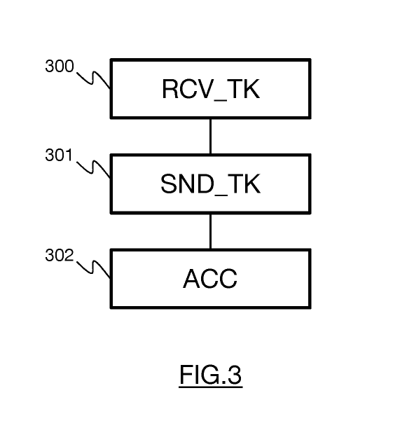

FIG. 3 illustrates the main steps of the method for accessing a service from a terminal. The terminal 106 in FIG. 1 is equipped with a photosensitive sensor designed to receive data broadcast by a data transmission device using modulation of visible light producing a light beam.

When it is in range of the light beam, at the step 300, the terminal receives a token for accessing the service generated by the server 100 and broadcast by the device 104. The transmission is carried out according to a protocol for communication by visible light (VLC, for Visible Light Communication in English) such as the Li-Fi standard for example.

At the step 301, the terminal sends out, via a network interface such as for example a Wi-Fi interface, a request for accessing a service comprising the access token received at the step 300. For example, the terminal 106 sends out an http request GET to which the token is added when it tries to access a web page available on the Internet. The request is directed to the default gateway configured when the terminal is connected to the Wi-Fi network, in other words for example to the server 100.

The terminal can access the on-line service at the step 302 when the token is valid.

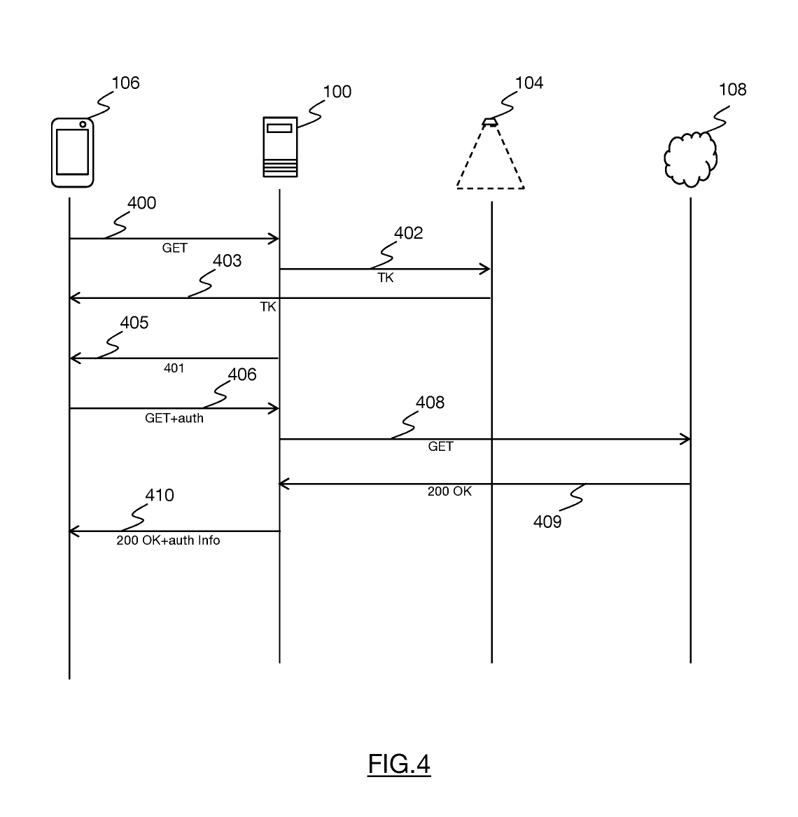

FIG. 4 is a timing diagram illustrating messages exchanged between various elements of the architecture shown in FIG. 1 designed to implement the invention according to one particular embodiment. This embodiment using the http protocol for accessing a web service is presented purely by way of example, the invention being able to be implemented by means of other appropriate transmission protocols. For example, the SIP protocol may be used to implement the invention for accessing a voice communications or instant messaging service.

The terminal 106 sends out a first http request 400 of the GET type in order to download for example a page from an Internet server. The request is intercepted by the server 100 since a default gateway corresponding to the server 100 has been configured on the terminal when it connected to the network according to a conventional address allocation technique. When it receives the request 400, the server 100 generates a token for accessing the service according to the step 200 previously described. For example, this generation step is carried out by reading a user name and a password in a configuration file of the server. The token is transmitted to the device 104 for transmission by visible light using a control message 402. This message transits for example via the electrical supply system according to a PLC (Power-Line Communications) technology in order to reach the device 104. The device 104 broadcasts the token within a message 403 using light modulation according to a protocol for visible light transmission conforming for example to the Li-Fi standard. The token may be broadcast to all the terminals located within range of the light beam according to a broadcast technique or else transmitted to one particular terminal according to a conventional unicast addressing technique. In response to the intercepted request 400, the server sends out a response 405 of the “401 Unauthorized” or “407 proxy authentication required” type according to the http protocol. This type of response is well known in the http protocol when accessing a protected resource and invites a terminal to show that it knows a user name and a password authorizing it to access a particular resource. Such a response comprises an identification request in the form of a header “WWW-Authenticate”. The terminal must then respond to this request for identification according to a method defined by the http protocol, such as for example the “Digest” method well known to those skilled in the art, which consists in applying a hash function of the MD5 or SHA type to certain data values present in the invitation from the server to which the terminal adds a secret data value, such as for example a user name and a password. According to one particular embodiment of the invention, the secret data value used for responding to the invitation from the server is included in the token transmitted by modulation of visible light and received by the terminal. Thus, only a terminal present in the light beam within which the token is transmitted can respond to the identification request. The terminal can then send out a new request for accessing the service 406 to which it adds a header “Authorization” constructed by means of the access token received in the message 403. When the identification is valid, in other words when the authentication data is validated according to the step 203, the server re-transmits the request 408 to the destination network and relays the response “200 OK” 409 from the remote service to the terminal by means of the message 410. The message 410 may furthermore comprise an http header “Authentication-Info” containing information on the successful identification and the next authentication.

According to one particular embodiment, the token generated by the server is associated with identification data for the terminal obtained upon receiving a first request for accessing the service sent by the terminal. The data for identification of the terminal may be obtained in various ways. For example, the terminal can transmit this information in an adapted field of the request. According to another embodiment, the server can obtain an identifier for the terminal using the protocol ARP (Address Resolution Protocol) which allows the MAC (Media Access Control) address of a terminal to be obtained from its IP address. Since a MAC address is unique, it can be used as an identifier of the terminal. Since the token is generated in association with the data for identification of the terminal, and the step for verifying the validity of the token furthermore comprises a verification of the correspondence between the token generated and the data for identification of the terminal, the method is able to guarantee that a token can only be used by a particular terminal.

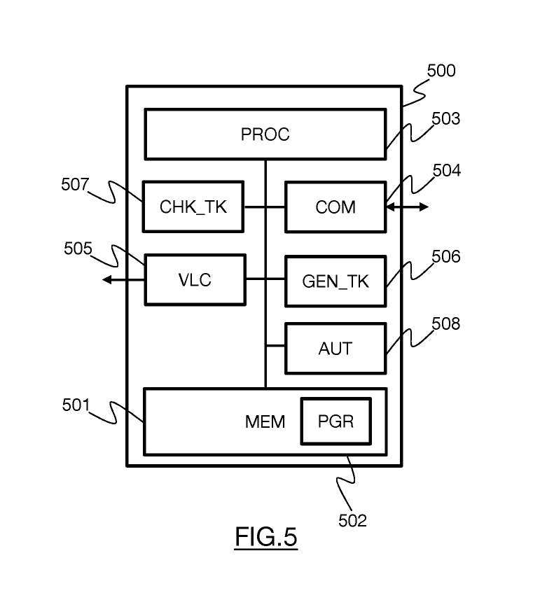

FIG. 5 illustrates a device 500 implementing the method for controlling the access to a service, according to one particular embodiment of the invention. The device comprises a storage space 501, for example a memory MEM, a processing unit 503 equipped for example with a processor PROC. The processing unit may be controlled by a program 502, for example a computer program PGR, implementing the method for controlling the access to a service such as described in the invention with reference to FIG. 2, and notably the steps for generating a token for accessing the service, for sending a command for broadcasting the token for accessing the service by the data transmission device using modulation of visible light, and when the terminal is in range of the light beam, for receiving, via the communications network, a request for accessing the service comprising a token for accessing the service originating from the terminal, for verifying the validity of the access token, and for authorization of the access to the service when the token is valid.

Upon initialization, the instructions of the computer program 502 are for example loaded into a RAM (Random Access Memory in English) memory prior to being executed by the processor of the processing unit 503. The processor of the processing unit 503 implements the steps of the method for controlling the access to a service according to the instructions of the computer program 502.

For this purpose, aside from the memory 501, the device comprises a communications unit 504 (COM) allowing the device to connect to a telecommunications network and to exchange data with other devices via the telecommunications network, and, in particular, to send out responses to the requests sent by a terminal and to relay requests sent by a terminal when the validity of identification data such as an access token is verified. This communications unit may be a network interface of the Ethernet, CPL, Wi-Fi type, or again an Internet access unit such as for example an ADSL interface or optical fiber. According to one particular embodiment, the device furthermore comprises a device 505 for transmission of data by modulation of visible light. This transmission device may for example correspond to an LED illumination device adapted for transmitting data within the light beam according to the Li-Fi standard. According to one particular embodiment, the server comprises a communications interface allowing such a transmission device using modulation of visible light to be controlled. Such an interface is designed to transmit instructions and data to the device such as for example a command for transmission of a token for accessing the service to one or more terminals within range of the light beam. This interface may be a communications interface of the Wi-Fi, Bluetooth, USB or else for example CPL type. The device also comprises, according to one particular embodiment, a unit for generating an access token 506 such as for example a GEN_TK unit for random generation of a user name and a password. The device furthermore comprises a unit for verifying the validity of an access token 507 such as for example a comparator CHK_TK, designed to verify the validity of a token according to the step 203 of the method. The device furthermore comprises an access authorization unit 508 AUT designed to relay an access request sent by the terminal to the destination service when the token is valid.

According to one particular embodiment of the invention, the access control device is integrated into a server, a domestic gateway or a Wi-Fi router.

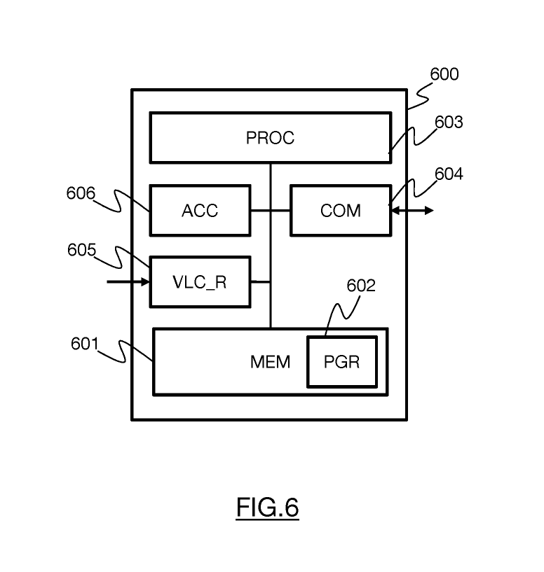

FIG. 6 illustrates a device 600 implementing the method for accessing a service, according to one particular embodiment of the invention. The device comprises a storage space 601, for example a memory MEM, a processing unit 603 equipped for example with a processor PROC. The processing unit may be controlled by a program 602, for example a computer program PGR, implementing the method for accessing a service such as described in the invention with reference to FIG. 3, and notably the steps for receiving a token for accessing the service via a communications interface designed to receive data transmitted by modulation of visible light, for sending, via a communications network and for the attention of the access control server, an access request comprising the access token received and for accessing the service when the token is valid.

Upon initialization, the instructions of the computer program 602 are for example loaded into a RAM (Random Access Memory in English) memory prior to being executed by the processor of the processing unit 603. The processor of the processing unit 603 implements the steps of the method for accessing a service according to the instructions of the computer program 602.

For this purpose, aside from the memory 601, the device comprises a communications unit 604 (COM) designed to send out, via a communications network and for the attention of the access control server, an access request comprising an access token. This communications unit may be an Ethernet network card, a Wi-Fi interface or else for example Bluetooth. According to one particular embodiment, the device furthermore comprises a communications unit designed to receive a token for accessing the service broadcast by a data transmission device using modulation of visible light producing a light beam, such as for example a sensor 605 (VLC_R) designed to receive data transmitted by modulation of visible light. This sensor may for example be an adapted photovoltaic cell or a camera and may be integrated into the terminal or connected to the terminal via a communications interface. According to one particular embodiment, the sensor may be integrated into a touch screen of the terminal. The device also comprises a unit 606 for accessing the service (ACC) designed to identify itself to the server by means of the access token received.

According to one particular embodiment of the invention, the access device is integrated into a mobile terminal of the smartphone type, a laptop computer, an on-line object or a peripheral device of the USB stick type.

The invention also relates to a system for controlling the access to a service comprising a device for controlling the access to a service, a device for accessing a service and a device for data transmission using visible light. FIG. 1 shows one example of such a system in which an access control device is integrated into the server 100, an access device is integrated into the terminal 106 and the device for transmission by modulation of visible light corresponds to the lamp 104.

1. Method for controlling the access to an on-line service, the access to the service being requested, via a communications network, by a terminal designed to receive data broadcast by a data transmission device using modulation of visible light producing a light beam, the method being characterized in that it comprises the following steps implemented by a server:
Generation (200) of a token for accessing the service,
Sending (201) of a command for broadcasting the token for accessing the service by the data transmission device using modulation of visible light, and
When the terminal is in range of the light beam:
Reception (202), via the communications network, of a request for accessing the service comprising a token for accessing the service originating from the terminal,
Verification (203) of the validity of the access token, and
Authorizing access (204) when the token is valid.

2. Method according to claim 1, characterized in that it furthermore comprises a step for revoking the access token after the expiration of a validity period associated with the token.

3. Method according to claim 1, characterized in that the steps for generation of a token and for sending a broadcast command are periodically repeated.

4. Method according to claim 1, characterized in that it comprises the following initial steps:
Reception, via the communications network, of an initial request for accessing the service originating from the terminal,
Obtaining identification data for the terminal,
The token being generated in association with the data for identification of the terminal and the step for verification of the validity of the token furthermore comprising a verification of the correspondence between the token generated and the data for identification of the terminal.

5. Method for accessing a service on a terminal designed to receive data broadcast by a data transmission device using modulation of visible light producing a light beam, the method being characterized in that it comprises the following steps when the terminal is in range of the light beam:
Reception of a token for accessing the service via a communications interface designed to receive data transmitted by modulation of visible light,
Sending, via a communications network and for the attention of an access control server, of an access request comprising the access token received, and
Access to the service when the token is valid.

6. Device for controlling the access to an on-line service, the access to the service being requested by a terminal designed to receive data broadcast by a data transmission device using modulation of visible light producing a light beam, the device comprising:
A unit for generating an access token,
A communications interface designed to control the broadcast of the access token in the light beam generated by the data transmission device via modulation of visible light,
A communications interface designed to receive a request for accessing the service comprising an access token originating from the terminal,
A monitoring unit for verifying the validity of the access token, and
An authorization unit for authorizing the access to the service when the token is valid.

7. Device for accessing a service comprising:
A communications unit designed to receive a token for accessing the service broadcast by a data transmission device using modulation of visible light producing a light beam,
A communications unit designed to send, via a communications network and for the attention of an access control server, an access request comprising the access token received, and
An access unit for accessing the service.

8. System for controlling the access to a service, characterized in that it comprises:
An access control device for controlling the access to an on-line service, the access to the service being requested by a terminal designed to receive data broadcast by a data transmission device using modulation of visible light producing a light beam, the device comprising:
A unit for generating an access token,
A communications interface designed to control the broadcast of the access token in the light beam generated by the data transmission device via modulation of visible light,
A communications interface designed to receive a request for accessing the service comprising an access token originating from the terminal,
A monitoring unit for verifying the validity of the access token, and
An authorization unit for authorizing the access to the service when the token is valid,
A device for accessing the service comprising:
A communications unit designed to receive a token for accessing the service broadcast by a data transmission device using modulation of visible light producing a light beam,
A communications unit designed to send, via a communications network and for the attention of an access control server, an access request comprising the access token received, and
An access unit for accessing the service,
A data transmission device using modulation of visible light producing a light beam.

9. Server, characterized in that it comprises an access control device for controlling the access to an on-line service, the access to the service being requested by a terminal designed to receive data broadcast by a data transmission device using modulation of visible light producing a light beam, the device comprising:
A unit for generating an access token,
A communications interface designed to control the broadcast of the access token in the light beam generated by the data transmission device via modulation of visible light,
A communications interface designed to receive a request for accessing the service comprising an access token originating from the terminal,
A monitoring unit for verifying the validity of the access token, and
An authorization unit for authorizing the access to the service when the token is valid.

10. Terminal, characterized in that it comprises an access device comprising:
A communications unit designed to receive a token for accessing the service broadcast by a data transmission device using modulation of visible light producing a light beam,
A communications unit designed to send, via a communications network and for the attention of an access control server, an access request comprising the access token received, and
An access unit for accessing the service.

11. Computer program comprising the instructions for the execution of the access control method for controlling the access to an on-line service, the access to the service being requested, via a communications network, by a terminal designed to receive data broadcast by a data transmission device using modulation of visible light producing a light beam, the method being characterized in that it comprises the following steps implemented by a server:
Generation (200) of a token for accessing the service,
Sending (201) of a command for broadcasting the token for accessing the service by the data transmission device using modulation of visible light, and
When the terminal is in range of the light beam:
Reception (202), via the communications network, of a request for accessing the service comprising a token for accessing the service originating from the terminal,
Verification (203) of the validity of the access token, and
Authorizing access (204) when the token is valid, and/or the instructions for the execution of the access method for accessing a service on a terminal designed to receive data broadcast by a data transmission device using modulation of visible light producing a light beam, the method being characterized in that it comprises the following steps when the terminal is in range of the light beam:
Reception of a token for accessing the service via a communications interface designed to receive data transmitted by modulation of visible light,
Sending, via a communications network and for the attention of an access control server, of an access request comprising the access token received, and
Access to the service when the token is valid, when the program is executed by a processor.

12. Information medium readable by a processor on which a computer program is recorded comprising instructions for the execution of the steps of the access control method for controlling the access to an on-line service, the access to the service being requested, via a communications network, by a terminal designed to receive data broadcast by a data transmission device using modulation of visible light producing a light beam, the method being characterized in that it comprises the following steps implemented by a server:
Generation (200) of a token for accessing the service,
Sending (201) of a command for broadcasting the token for accessing the service by the data transmission device using modulation of visible light, and
When the terminal is in range of the light beam:
Reception (202), via the communications network, of a request for accessing the service comprising a token for accessing the service originating from the terminal,
Verification (203) of the validity of the access token, and
Authorizing access (204) when the token is valid, and/or the instructions for the execution of the access method for accessing a service on a terminal designed to receive data broadcast by a data transmission device using modulation of visible light producing a light beam, the method being characterized in that it comprises the following steps when the terminal is in range of the light beam:
Reception of a token for accessing the service via a communications interface designed to receive data transmitted by modulation of visible light,
Sending, via a communications network and for the attention of an access control server, of an access request comprising the access token received, and
Access to the service when the token is valid.

13. Method according to claim 2, characterized in that the steps for generation of a token and for sending a broadcast command are periodically repeated.

14. Method according to claim 2, characterized in that it comprises the following initial steps:
Reception, via the communications network, of an initial request for accessing the service originating from the terminal,
Obtaining identification data for the terminal,
The token being generated in association with the data for identification of the terminal and the step for verification of the validity of the token furthermore comprising a verification of the correspondence between the token generated and the data for identification of the terminal.

15. Method according to claim 3, characterized in that it comprises the following initial steps:
Reception, via the communications network, of an initial request for accessing the service originating from the terminal,
Obtaining identification data for the terminal,
The token being generated in association with the data for identification of the terminal and the step for verification of the validity of the token furthermore comprising a verification of the correspondence between the token generated and the data for identification of the terminal.
